(19) United States
(12) Patent Application Publication
(10) Pub. No.: US 2020/0202718 A1
(43) Pub. Date: Jun. 25, 2020

(54) UNEXPECTED SITUATION SCENARIO REALIZATION SYSTEM AND ITS METHOD FOR MAINTENANCE AND PERFORMANCE EVALUATION OF TRAFFIC INFORMATION COLLECTION APPARATUS

(71) Applicant: Korea Institute of Civil Engineering and Building Technology, Gyeonggi-do (KR)

(72) Inventors: SangHyup Lee, Seoul (KR); KyungChan Jang, Seoul (KR)

(21) Appl. No.: 16/696,800

(22) Filed: Nov. 26, 2019

(30) Foreign Application Priority Data
Dec. 20, 2018 (KR) 10-2018-0165941

(51) Int. Cl. G08G 1/16; B60W 30/09; B60W 30/095; G07C 5/08; G06K 9/00; H04H 20/55

(52) U.S. Cl. CPC G08G 1/166; B60W 30/09; B60W 30/0956; H04H 20/55; G06K 9/00805; G06K 9/00369; G07C 5/0891

(57) ABSTRACT

According to one aspect of the present invention, an unexpected situation scenario realization system for maintenance and performance evaluation of a traffic information collection apparatus may comprise a central control device provided inside a vehicle to realize and control an unexpected situation scenario, a camera provided in a rear and a front of the vehicle, respectively, to film the unexpected situation scenario, and a controller to process an algorism of the realized unexpected situation scenario that is associated with the central control device.

### TECHNICAL FIELD

The present invention relates to unexpected situation scenario realization system and its method for maintenance and performance evaluation of a traffic information collection apparatus, more specifically to unexpected situation scenario realization system and its method for maintenance and performance evaluation of a traffic information collection apparatus that can evaluate performance of an information collection device of an unexpected situation detection system.

### BACKGROUND ART

An unexpected situation detection system (AIDS: Automatic Incident Detection System) will be installed in high-speed national roads, general national roads and provincial roads across the country as part of the Intelligent Transport System (ITS).

The above unexpected situation detection system detects events such as accidents occurred on the road, falling objects, pedestrians, etc. and notifies roads administrators for them to promptly response and handle, and it is important how quickly and accurately the unexpected situation occurred on the road is detected. Accordingly, it is stipulated by the State that the accuracy of ITS equipment is assessed at regular intervals to maintain functions and performance above a certain level in accordance with Article 86 of National Transport System Efficiency Act.

However, the criteria presented by the State requires various test procedures such as numerous test vehicles, falling objects, pedestrians etc., thus it is too much to apply to existing ITS performance evaluation systems, and it is a significantly high cost structure when roughly comparing the manpower and cost required for necessary vehicles and their driving.

This problem results into an increase in the cost of assessing performance, which in turn undermines the reliability of the ITS performance assessment system as such cost-burdens lead ITS task operators to be more likely to avoid the performance assessment.

In addition, when conducting an assessment as provided in the performance evaluation criteria, the assessment body (or evaluator) should implement random unexpected situations and conduct the assessment using various scenarios, such as stationary vehicles, reverse-driving vehicles, pedestrians and falling objects etc., but all situations are conducted manually by the personnel, therefore it fails to maintain consistency for numerous repeated assessments, which results into lacking objectivity and leads to the public complaint or distrust of the assessment.

### DISCLOSURE

### Technical Problem

An objective of the present invention is to solve such problems and is to provide unexpected situation scenario realization system and its method for maintenance and performance evaluation of a traffic information collection apparatus that can provide reference data for performance evaluation of an unexpected situation detection system.

Also, an objective of the present invention is to unexpected situation scenario realization system and its method for maintenance and performance evaluation of a traffic information collection apparatus that has high objectivity and efficiency in performance evaluation.

### Technical Solution

In order to achieve the above objects, according to one embodiment of the present invention, an unexpected situation scenario realization system for maintenance and performance evaluation of a traffic information collection apparatus comprises a central control device provided inside a vehicle to realize and control an unexpected situation scenario; a camera provided in a rear and a front of the vehicle, respectively, to film the unexpected situation scenario; a controller that is associated with the central control device to process an algorism of the realized unexpected situation scenario; and a traffic information collection apparatus installed in a road side to sense realized unexpected situation and collect traffic information.

The unexpected situation scenario that is realized via the central control device may be one of sudden stop, reverse-driving, pedestrian emergence or falling object emergence.

A RF receiver that transmits and receives data with a pedestrian detection apparatus of pedestrian on road is further provided to the vehicle at a time of performance evaluation in an unexpected situation of the pedestrian emergence of the traffic information collection apparatus.

A magnetic electromagnet that loads or drops the falling object using electromagnetic force is further provided to the vehicle at a time of performance evaluation in an unexpected situation of the falling object emergence of the traffic information collection apparatus.

Also, in order to achieve the above objects, according to another embodiment of the present invention, an unexpected situation scenario realization method for maintenance and performance evaluation of a traffic information collection apparatus comprises letting a vehicle wait in a middle inside a detection area of the traffic information collection apparatus; inputting a specification of the traffic information collection apparatus; inputting into a central control device information provided by the vehicle being driven; automatically stopping a distance measurement in the central control device when a distance is 500 meters at maximum from the traffic information collection apparatus; classifying into a first section to a fifth section after a re-measured result value is produced once the vehicle is U-turned; realizing of a falling object sudden stop scenario by a passenger of the vehicle dropping the falling object in a second section, making a sudden stop of the vehicle in a third section; recording in the central control device dropping time and sudden stop time of falling object; terminating of the falling object sudden stop scenario at a moment that the vehicle deviates away from 500 meters once the vehicle is suddenly stopped; saving images via a camera installed on the vehicle; converting into a reverse-driving mode and realizing a falling object sudden stop scenario when the vehicle that is U-turned again enters a 500-meter detection area; and saving images via a camera installed on the vehicle.

Also, in order to achieve the above objects, according to yet another embodiment of the present invention, an unexpected situation scenario realization method for maintenance and performance evaluation of a traffic information collection apparatus comprises letting a vehicle wait in a middle inside a detection area of the traffic information collection apparatus; inputting a specification of the traffic information collection apparatus; inputting into a central control device information provided while the vehicle is driven; automatically stopping a distance measurement in the central control device when a distance is 500 meters at maximum from the traffic information collection apparatus; classifying into a first section to a fifth section after a re-measured result value is produced once the vehicle is U-turned; realizing of a pedestrian emergence scenario by a passenger entering any section; recording in the central control device pedestrian entrance information obtained from a pedestrian detection apparatus provided in the pedestrian; verifying whether a pedestrian is continuously detected once the vehicle enters the any section that the pedestrian enters; and saving images via a camera installed on the vehicle.

A type and a detection distance of the traffic information collection apparatus is inputted when a specification of the traffic information collection apparatus is inputted.

### Advantageous Effects

According to the present invention, the unexpected situation scenario realization system and its method for maintenance and performance evaluation of a traffic information collection apparatus can provide reference data for performance evaluation of an unexpected situation detection system.

Further, higher objectivity and efficiency can be given to the performance evaluation.

### BRIEF DESCRIPTION OF DRAWINGS

FIGS. 1 to 2 show an unexpected situation scenario realization system for maintenance and performance evaluation of a traffic information collection apparatus according to one embodiment of the present invention.

FIGS. 3 to 6 show an unexpected situation scenario realization method for maintenance and performance evaluation of a traffic information collection apparatus according to one embodiment of the present invention.

### DETAILED DESCRIPTION

Hereinafter, unexpected situation scenario realization system and its method for maintenance and performance evaluation of a traffic information collection apparatus will be described in detail with reference to the accompanying drawings as follows.

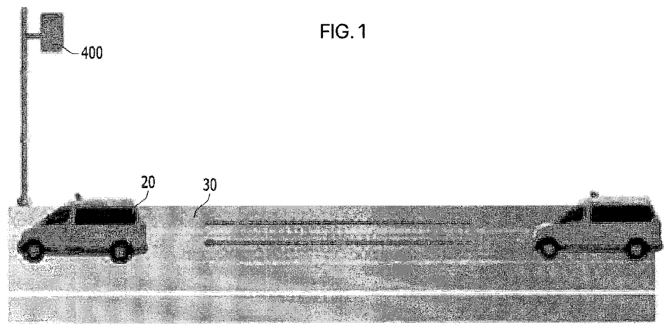

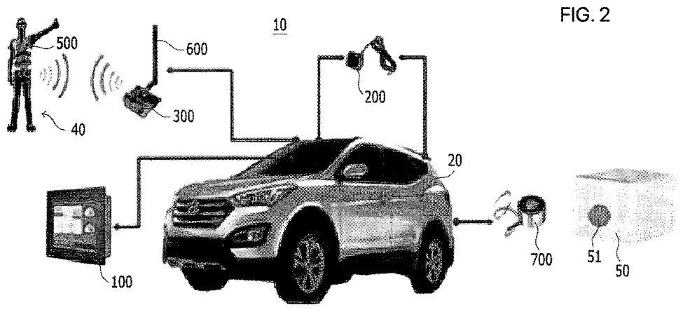

FIGS. 1 to 2 show the unexpected situation scenario realization system for maintenance and performance evaluation of a traffic information collection apparatus according to one embodiment of the present invention.

As shown in FIGS. 1 and 2, the unexpected situation scenario realization system (10) for maintenance and performance evaluation of a traffic information collection apparatus according to one embodiment of the present invention may comprise a central control device (100), a camera (200), a controller (300), and a traffic information collection apparatus (400).

The central control device (100) is provided inside a vehicle (20) via a cradle (not shown), and is installed a scenario software that may implement and test-operate an unexpected situation scenario, thereby may realize the unexpected situation scenario. The unexpected situation scenario that is realized via the central control device (100) may be sudden stop, reverse-driving, pedestrian emergence or falling object emergence etc. A controller (300), a pedestrian detection apparatus (500), a RF receiver (600) and fall of a falling object (50) as described below are controlled, and images filmed via a camera (200) are saved and used as evidence material.

The camera (200) is provided in a rear and a front of the vehicle (20), respectively, and films situation of road (30) when the unexpected situation scenario is realized via the central control device (100).

The controller (300) is associated with the central control device (100) and may process an algorism of the unexpected situation scenario that is realized via the central control device (100). Alike the central control device (100), the controller (300) is also provided inside the vehicle (20) and may be detached from and attached to the vehicle (20) using an absorption plate (not shown).

A traffic information collection apparatus (400) is installed in a road (30) side to sense unexpected situation realized by the central control device (100), and to collect traffic information, and to analyze the collected traffic information which is then estimated unexpected situation detection performance. Thereby, the traffic information collection apparatus (400) may be changed depending on an entity to be evaluated.

Also, the unexpected situation scenario realization system for maintenance and performance evaluation of a traffic information collection apparatus may be further provided with a RF receiver (600) and a magnetic electromagnet (700) depending on the unexpected situation scenario.

The RF receiver (600) is provided inside the vehicle (20), and transmits and receives data with a pedestrian detection apparatus (500) of pedestrian (40) positioned on road (30) at a time of performance evaluation in an unexpected situation of the pedestrian emergence of the traffic information collection apparatus (400). Information of pedestrian (40) is recorded into the central control device (100) via data that is transmitted and received via the pedestrian detection apparatus (500) and the RF receiver (600), and the traffic information collection apparatus (400) may be evaluated performance by verifying whether the traffic information collection apparatus (400) continuously detects pedestrian (40).

The magnetic electromagnet (700) is provided inside the vehicle (20), and loads or drops the falling object (50) at a time of performance evaluation in an unexpected situation of the falling object emergence of the traffic information collection apparatus (400). Here, the falling object (50) is provided with a magnet (51) and may drop the falling object (50) loaded to the vehicle (20) into a desired position by fall of the falling object (50) being decided using electromagnetic force via the central control device (100). Dropping time of the falling object (50) and sudden stop time of the vehicle (20) are recorded in the central control device (100).

Now, the unexpected situation scenario realization method for maintenance and performance evaluation of a traffic information collection apparatus according to one embodiment of the present invention is explained. In the following explanations, only different features from the foregoing embodiment are described in further detail and features identical or very similar features are not explained again.

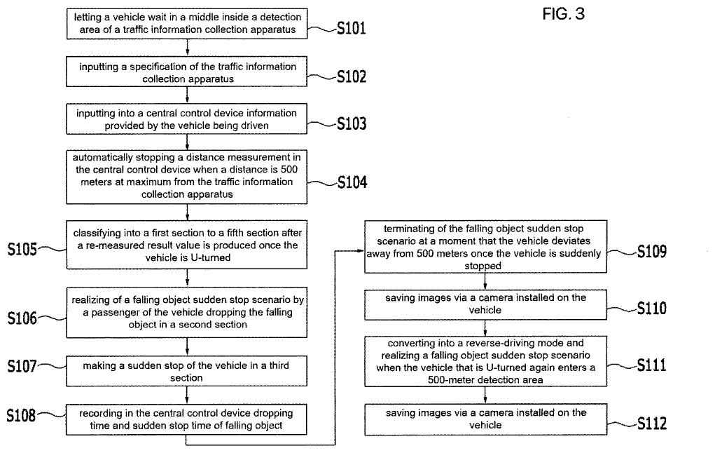

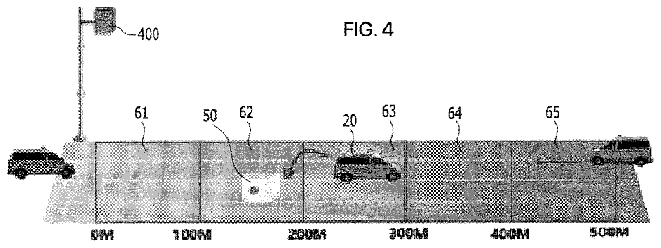

FIGS. 3 to 4 show an unexpected situation scenario realization method for maintenance and performance evaluation of a traffic information collection apparatus according to one embodiment of the present invention.

Referring to FIGS. 1 to 4, an unexpected situation scenario realization method for maintenance and performance evaluation of a traffic information collection apparatus according to another embodiment of the present invention comprises letting a vehicle (20) wait in a middle inside a detection area of the traffic information collection apparatus (400) (S101), inputting a specification of the traffic information collection apparatus (400) (S102), inputting into a central control device (100) information provided while the vehicle (20) is driven (S103), automatically stopping a distance measurement in the central control device (100) when a distance is 500 meters at maximum from the traffic information collection apparatus (400) (S104), classifying into a first section (61) to a fifth section (65) after a re-measured result value is produced once the vehicle (20) is U-turned (S105), realizing of a falling object sudden stop scenario by a passenger of the vehicle (20) dropping the falling object (50) in a second section (62) (S106), making a sudden stop of the vehicle (20) in a third section (63) (S107), recording in the central control device (100) dropping time and sudden stop time of falling object (50) (S108), terminating of the falling object sudden stop scenario at a moment that the vehicle (20) deviates away from 500 meters once the vehicle is suddenly stopped (S109), saving images via a camera (200) installed on the vehicle (20) (S110), converting into a reverse-driving mode and realizing a falling object sudden stop scenario when the vehicle (20) that is U-turned again enters a 500-meter detection area (S111), and saving images via a camera (200) installed on the vehicle (20) (S112).

The above method is to realize the falling object sudden stop scenario among unexpected situation scenarios and can evaluate performance of the traffic information collection apparatus (400) in an unexpected situation occurred by the falling object (50).

Above all, a vehicle (20) waiting in a middle inside a detection area of the traffic information collection apparatus (400) is loaded the falling object (50) and is inputted numerous information into the central control device (100) at the same time of driving. In addition, a distance measurement is automatically stopped when a distance is 500 meters away from the traffic information collection apparatus (400), and 500 meters is divided with a unit of 100 meter and is classified into a first section (61) to a fifth section (65). After the classification, a falling object sudden stop scenario is realized by dropping the falling object (560) from the vehicle (20).

A type and a detection distance of the traffic information collection apparatus (400) may be inputted in inputting (S102) a specification of the traffic information collection apparatus (400), and electromagnetic force of the magnetic electromagnet (700) is controlled via the central control device (100) in realizing (S106) of a falling object sudden stop scenario by a passenger of the vehicle (20) dropping the falling object in a second section (62) thereby it is allowed that the falling object (50) loaded in the vehicle (20) may be dropped into the second section (62).

Now, the unexpected situation scenario realization method for maintenance and performance evaluation of a traffic information collection apparatus according to another embodiment of the present invention is explained. In the following explanations, only different features from the foregoing embodiment are described in further detail and features identical or very similar features are not explained again.

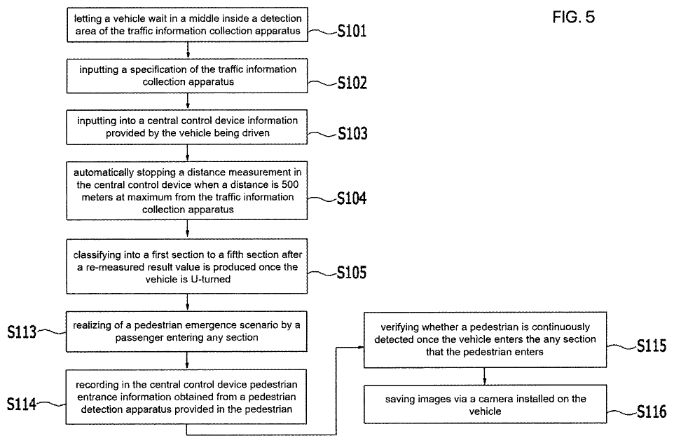

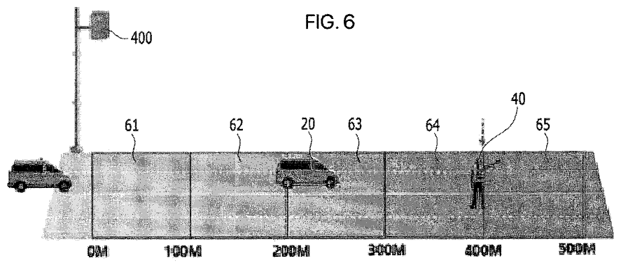

FIGS. 5 to 6 show an unexpected situation scenario realization method for maintenance and performance evaluation of a traffic information collection apparatus according to another embodiment of the present invention.

Referring to FIGS. 1 to 6, according to another embodiment of the present invention, an unexpected situation scenario realization method for maintenance and performance evaluation of a traffic information collection apparatus comprises letting a vehicle (20) wait in a middle inside a detection area of the traffic information collection apparatus (40) (S101), inputting a specification of the traffic information collection apparatus (400) (S102), inputting into a central control device (100) information provided while the vehicle (20) is driven (S103), automatically stopping a distance measurement in the central control device (100) when a distance is 500 meters at maximum from the traffic information collection apparatus (400) (S104), classifying into a first section (61) to a fifth section (65) after a re-measured result value is produced once the vehicle (20) is U-turned (S105), realizing of a pedestrian emergence scenario by a passenger (40) entering any section (S113), recording in the central control device (100) pedestrian entrance information obtained from a pedestrian detection apparatus (500) provided in the pedestrian (40) (S114), verifying whether a pedestrian (40) is continuously detected once the vehicle (20) enters the any section that the pedestrian (40) enters (S115), and saving images (200) via a camera installed on the vehicle (20) (S116).

The above method is to realize the pedestrian emergency scenario among unexpected situation scenarios and can evaluate performance of the traffic information collection apparatus (400) in an unexpected situation occurred by the pedestrian (40) emergency.

Above all, a vehicle (20) is waiting in a middle inside a detection area of the traffic information collection apparatus (400) and the pedestrian (40) wearing a safety vest (not shown) that is provided with a pedestrian detection apparatus (500) is waiting. Numerous information is inputted into the central control device (100) at the same time of driving. In addition, a distance measurement is automatically stopped when a distance is 500 meters away from the traffic information collection apparatus (400), 500 meters is divided with a unit of 100 meter and is classified into a first section (61) to a fifth section (65). After the classification, a pedestrian emergence scenario is realized by a passenger (40) who is waiting entering any section.

Although unexpected situation scenario realization system and its method for maintenance and performance evaluation of a traffic information collection apparatus according to one embodiment of the present invention have been described as above, the spirit of the present invention is not limited to the embodiments shown in this specification. Also, those skilled in the art, who understand the spirit of the invention, can readily suggest other embodiments by adding, changing, deleting, introducing or the like of components, and the other embodiments are also within the scope of the invention.

### REFERENCE NUMERALS

10: unexpected situation scenario realization system
20: vehicle
30: road
40: pedestrian
50: falling object
51: magnet
61: a first section
62: a second section
63: a third section
64: a fourth section
65: a fifth section
100: central control device
200: camera
300: controller
400: traffic information collection apparatus
500: pedestrian detection apparatus
600: RF receiver
700: magnetic electromagnet

1. An unexpected situation scenario realization system for maintenance and performance evaluation of a traffic information collection apparatus comprising:
a central control device provided inside a vehicle to realize and control an unexpected situation scenario,
a camera provided in a rear and a front of the vehicle, respectively, to film the unexpected situation scenario,
a controller that is associated with the central control device to process an algorism of the realized unexpected situation scenario, and
a traffic information collection apparatus installed in a road side to sense the realized unexpected situation and collect traffic information.

2. The unexpected situation scenario realization system for maintenance and performance evaluation of a traffic information collection apparatus according to claim 1,
wherein the unexpected situation scenario that is realized via the central control device is one of sudden stop, reverse-driving, pedestrian emergence or falling object emergence.

3. The unexpected situation scenario realization system for maintenance and performance evaluation of a traffic information collection apparatus according to claim 2,
wherein a RF receiver that transmits and receives data with a pedestrian detection apparatus of a pedestrian positioned on road is further provided to the vehicle at a time of performance evaluation in an unexpected situation of the pedestrian emergence of the traffic information collection apparatus.

4. The unexpected situation scenario realization system for maintenance and performance evaluation of a traffic information collection apparatus according to claim 3,
wherein a magnetic electromagnet that loads or drops the falling object using electromagnetic force is further provided to the vehicle at a time of performance evaluation in an unexpected situation of the falling object emergence of the traffic information collection apparatus.

5. An unexpected situation scenario realization method for maintenance and performance evaluation of a traffic information collection apparatus comprising:
letting a vehicle wait in a middle inside a detection area of the traffic information collection apparatus,
inputting a specification of the traffic information collection apparatus,
inputting into a central control device information provided by the vehicle being driven,
automatically stopping a distance measurement in the central control device when a distance is 500 meters at maximum from the traffic information collection apparatus,
classifying into a first section to a fifth section after a re-measured result value is produced once the vehicle is U-turned,
realizing of a falling object sudden stop scenario by a passenger of the vehicle dropping the falling object in a second section,
making a sudden stop of the vehicle in a third section,
recording in the central control device dropping time and sudden stop time of the falling object,
terminating of the falling object sudden stop scenario at a moment that the vehicle deviates away from 500 meters once the vehicle is suddenly stopped,
saving images via a camera installed on the vehicle,
converting into a reverse-driving mode and realizing the falling object sudden stop scenario when the vehicle that is U-turned again enters a 500-meter detection area, and
saving images via a camera installed on the vehicle.

6. An unexpected situation scenario realization method for maintenance and performance evaluation of a traffic information collection apparatus comprising:
letting a vehicle wait in a middle inside a detection area of the traffic information collection apparatus,
inputting a specification of the traffic information collection apparatus,
inputting into a central control device information provided by the vehicle being driven,
automatically stopping a distance measurement in the central control device when a distance is 500 meters at maximum from the traffic information collection apparatus,
classifying into a first section to a fifth section after a re-measured result value is produced once the vehicle is U-turned,
realizing of a pedestrian emergence scenario by a passenger entering any section,
recording in the central control device pedestrian entrance information obtained from a pedestrian detection apparatus provided in the pedestrian,
verifying whether a pedestrian is continuously detected once the vehicle enters the any section that the pedestrian enters, and
saving images via a camera installed on the vehicle.

7. The unexpected situation scenario realization method for maintenance and performance evaluation of a traffic information collection apparatus according to claim 5,
wherein a type and a detection distance of the traffic information collection apparatus are inputted when a specification of the traffic information collection apparatus is inputted.

8. The unexpected situation scenario realization method for maintenance and performance evaluation of a traffic information collection apparatus according to claim 6,
wherein a type and a detection distance of the traffic information collection apparatus are inputted when a specification of the traffic information collection apparatus is inputted.
